(19) United States
(12) Patent Application Publication
(10) Pub. No.: US 2010/0106854 A1
(43) Pub. Date: Apr. 29, 2010

(54) SYSTEM AND METHOD FOR CONTROLLING NON-EXISTING DOMAIN TRAFFIC

(75) Inventors: JooYong Kim, Des Plaines, IL (US); Youngbae Oh, Chicago, IL (US); Simon Thomas Kirby, North Vancouver (CA)

Correspondence Address: BRINKS HOFER GILSON & LIONE, P.O. BOX 10395, CHICAGO, IL, 60610, US

(73) Assignee: Hostway Corporation, Chicago, IL (US)

(21) Appl. No.: 12/260,785

(22) Filed: Oct. 29, 2008

(51) Int. Cl. G06F 15/173

(52) U.S. Cl. 709/238

(57) ABSTRACT

A system and method for controlling internet traffic controls internet traffic directed to a non-existing domain in a centralized manner. Instead of a non-existing domain response, the user may receive alternative responses such as a landing page including useful information and resourceful suggestions under the control of a global controller. The centralized control over the user's request may be implemented by redirecting a DNS query to the global controller or an optimal search guide server at an individual internet service provider level. Redirection of the DNS query may involve a record modification of a domain name resolution response indicating the non-existing domain.

### BACKGROUND

1. Technical Field

This invention relates to an internet traffic control system and method and more particularly, to a system and method for controlling internet traffic directed to a non-existing domain.

2. Related Art

Users identify desired internet destinations with domain names composed of a series of alpha-numeric characters. Servers, which provide information and services requested by users, are identified with an internet protocol (“IP”) address composed of a series of numbers. In order for requests of users to reach servers, the requested domain names should be resolved to the IP address. A local internet service provider (“ISP”) provides a local domain name resolution server which is dedicated to the domain name resolution process. The local domain name server is designated and operated by the local internet service provider. The local name server communicates with various authorized domain name resolution servers such as a root name server, a top-level domain (“TLD”) name server, an authoritative name server, etc. Authorized domain name resolution servers may store “authoritative” IP addresses mapped to requested domain names.

A particular domain name requested by users may not exist. As one example, users may mistype or misspell domain names upon request. Users also may remember incorrect domain names. Authorized domain name resolution servers do not store IP addresses of non-existing domains in their database and return a non-existing domain response to users through the local domain name server. Users may obtain the non-existing domain response, for example, a simple error message indicating that the requested domain does not exist. This can be frustrating and confusing to the user who does not understand the nature of the error. Accordingly, there is a need to provide an improved system and method for controlling the non-existing domain request.

### SUMMARY OF THE INVENTION

Only by way of example, a system and method for controlling internet traffic controls internet traffic directed to a non-existing domain in a centralized manner. Instead of a non-existing domain response, the user may receive an alternative response such as information relating to a landing page including useful information and resourceful suggestions under the control of a global controller. The global controller resides at a network location preferably independent of local internet service providers (ISPs). The centralized control over the user's request may be implemented by redirecting a domain name service (DNS) query to the global controller at an individual ISP level. Redirection of the DNS query may involve a record modification of the non-existing domain response.

In one embodiment, an internet traffic control method for a non-existing domain includes installing a DNS module, receiving a DNS query directed to the non-existing domain at the DNS module, redirecting to a controller the DNS query by the DNS module, receiving at the central controller the DNS query directed to the non-existing domain, determining an optimal search guide server operable to provide an alternative response to a non-existing domain request, sending the IP address of the optimal search guide server to a user application, and forwarding the IP address of the optimal search guide server to a user application which has sent the DNS query. The user application may be directed to access the optimal search guide server.

In another embodiment, an internet traffic control system for a non-existing domain includes a DNS module and a non-existing domain name controller. The DNS module is operable to redirect a DNS query for the non-existing domain and includes a redirector operable to modify a name server record of a domain name response data packet to the DNS query and indicative of the non-existing domain. The non-existing domain name controller is operable to receive the redirected DNS query and determine an optimal search guide server that provides an alternative response to a non-existing domain request informing a user application of the non-existing domain.

In yet another embodiment, an internet traffic control method for a non-existing domain includes operating a local name server to receive a DNS query from a user application comprising a browser. The DNS query includes a first DNS query directed to an existing domain and a second DNS query directed to the non-existing domain. The method also includes communicating with an authorized name server to resolve the first and the second DNS queries and receiving a DNS response from the authorized name server. The DNS response includes a first DNS response directed to the existing domain and a second DNS response directed to the non-existing domain. The method further includes modifying a record of the second DNS response, forwarding the first DNS response to the local name server without modification of the record, receiving the first and the second DNS responses at the local name server, determining at the non-existing domain name controller a search guide server operable to provide an alternative response to the user application which has sent the second DNS query, and returning a resultant IP address of the search guide server to the user application.

In yet another embodiment, an internet traffic control system for a non-existing domain includes means for receiving and processing a DNS query from a user application, means for redirecting the DNS query by modifying a predetermined record of the DNS response data packet to the DNS query, means for redirecting operable to determine that the DNS response data packet indicates the non-existing domain prior to the modification of the predetermined record, and means for controlling internet traffic directed to the non-existing domain by responding to a redirected DNS query, means for controlling operable to determine an optimal search guide server which provides an alternative response to the user application which has sent the redirected DNS query. The means for controlling further transmits an IP address of the optimal search guide server to the user application.

The means for controlling includes means for storing content information stored in a group of search guide servers, a network location of the group of the search guide servers, and predetermined criteria for defining the optimal search guide server at least based on the content information and the network location of the group of the search guide server. The means for controlling further includes a logic having an input of a domain name of the redirected DNS query and network location information of the user application and an output of a resultant search guide server. The logic is operable to generate the output based on the predetermined criteria. The logic is further operable to integrate in real time the content information and the network location of the group of search guide servers and update the predetermined criteria.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram illustrating a domain name resolution system for use with an internet.

FIG. 2 is a block diagram illustrating one embodiment of a non-existing domain traffic control system.

FIG. 3 is a block diagram illustrating control structure of a global non-existing domain traffic control system.

FIGS. 4-5 are flow charts illustrating operations of the centralized non-existing domain traffic control system of FIG. 2.

FIG. 6 is a block diagram illustrating signal flows of the centralized non-existing domain control of FIGS. 2 and 4-5.

FIG. 7 is a block diagram illustrating another embodiment of the centralized non-existing domain traffic control system.

FIG. 8 is a block diagram illustrating signal flows of the centralized non-existing domain control of FIG. 7.

FIG. 9 is a block diagram illustrating other embodiments of the non-existing domain traffic control system.

FIGS. 10-12 are flow charts illustrating operations of the non-existing domain traffic control system of FIG. 9.

### DETAILED DESCRIPTION OF THE PREFERRED EMBODIMENTS

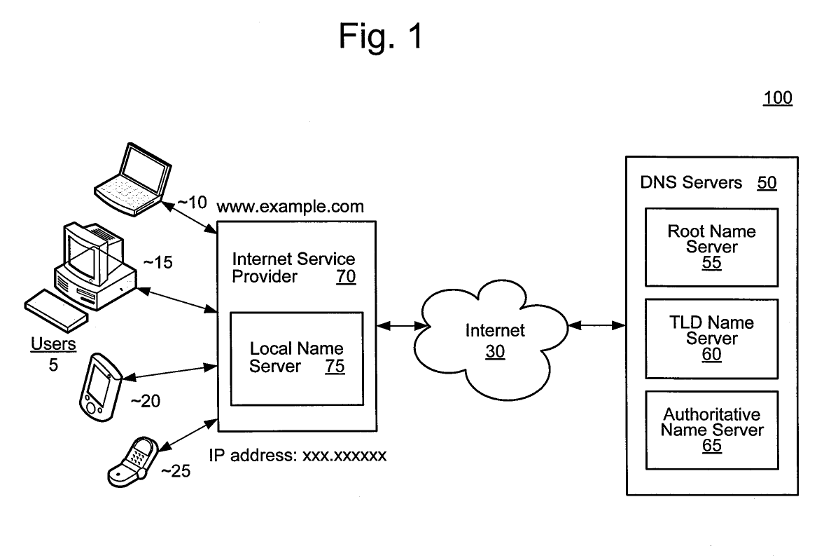

FIG. 1 is a block diagram of a system illustrating one example of a domain name resolution system for use with an internet. Users 5 include any data processing system with communication ability, such as a laptop 10, a desk top 15, a personal digital assistant (“PDA”) 20, a mobile phone 25, etc. The users 5 communicate with a network of computers across internet 30. An internet service provider 70 provides the users 5 with an internet connection required for connecting to the internet 30. Through the internet 30, users engage in various services, such as e-mail, file transfer, and the World Wide Web (“WWW”). The users 5 transmit data by packet switching using an internet protocol (“IP”) address.

The users 5 identify a computer or computers on the internet that contain the desired information and service by using a domain name. The domain name is represented as a part of a selected uniform resource locator. The users 5 are allowed to use alphanumeric addresses of the domain name instead of numerical IP addresses, thereby easily communicating with various websites. A local internet service provider (“ISP”) 70 provides internet connections and required services to the users 5. The local ISP 70 is equipped with a local domain name server 75 (“local name server”) which handles a domain name resolution process. The local name server 75 may be under the control of the local ISP 70. In FIG. 1, one local ISP and the local name server 75 are illustrated only for convenience of discussion. One or more local ISPs and local name servers are available. Also, users 10, 15, 20 and 25 may or may not use the same local ISP.

The local name server 75 receives a request from the users 5 and initiates the domain name resolution process. Specifically, the local name server 75 operates to find a corresponding IP address of the incoming domain name. For instance, when the user 10 requests the domain name of www.example.com, the local name server 75 operates to find the corresponding IP address of a server which will respond to the client's request. The local name server 75 may communicate with at least one of authorized domain name resolution servers 50, such as a root name server 55, a top-level-domain (“TLD”) name server 60, an authoritative name server 65, etc. The root name server 55 and the TLD name server 60 are defined and arranged by the internet's official global implementation of the domain name system. The authoritative name server 65 provides an authoritative answer to a domain name system (“DNS”) query. The authoritative name server 65 is registered with the TLD name server 60. By way of one example, a root name server 55 contains information of the TLD name server 60 for handling the .com zone of www.example.com. The TLD name server 60 contains information of the authoritative name server 65 which is registered to serve www.example.com. As a result of a DNS query, the local name server 75 receives information of the TLD name server 60 or the authoritative name server 65. When the TLD name server 60 provides name server records (NS records) of the authoritative name server 65, the local name server 75 obtains an IP address of the authoritative name server 65. The local name server 75 sends a DNS query to the authorized name server 65. As shown in FIG. 1, the local name server 75 resolves the domain name of www.example.com, e.g., to an IP address and forwards the IP address to the users 10.

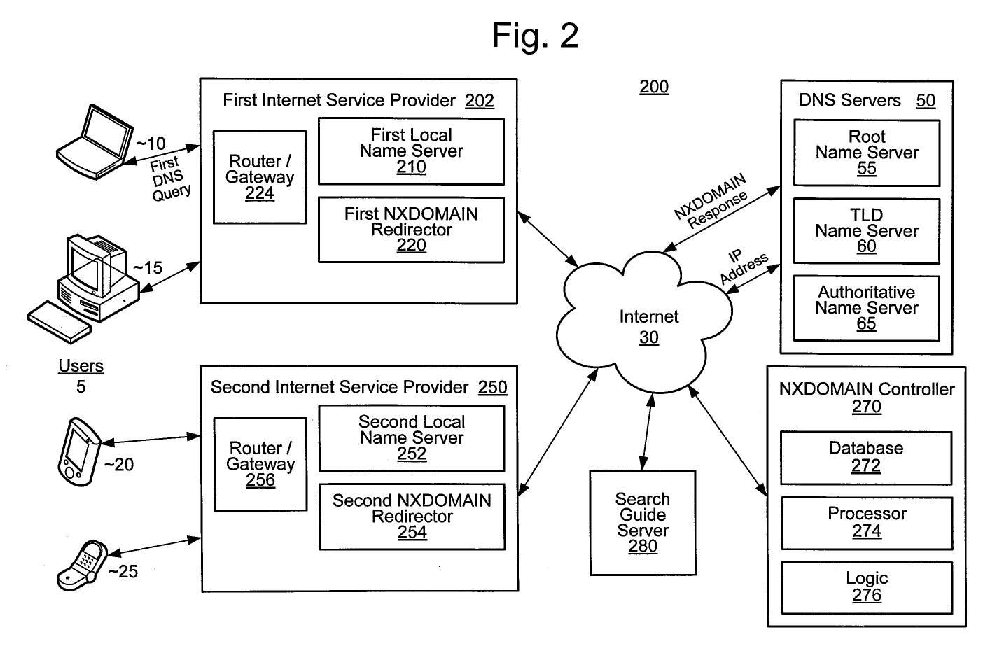

FIG. 2 is a block diagram illustrating one embodiment of an internet traffic control system 200 for a non-existing domain. The users 5, the internet 30 and the DNS servers 50 are described above in conjunction with FIG. 1. In FIG. 2, a first ISP 202 and a second ISP 250 provide the internet connection to the users 5. More specifically, the first ISP 202 connects users 10 and 15 with the internet 30 and the second ISP 250 connects users 20 and 25 with the internet 30. Only for explanation purposes, two ISPs 202 and 250 and their connections with the users 10, 15, 20 and 25 are described, but one of ordinary skill in the art would appreciate that more or less than two ISPs and various connections with multiple users are available.

The first ISP 202 includes a first local name server 210 and a first non-existing domain (“NXDOMAIN”) redirector 220. The first ISP 202 also includes a processor which controls any necessary operations of the first ISP 202 and storage for storing information required for the operations of the first ISP 202. Likewise, the second ISP 250 includes a second local name server 252 and a second NXDOMAIN redirector 254. In other embodiments, the first and/or the second local name servers 210 and 252 may reside and operate independently of the first and/or the second ISPs 202 and 250. The second ISP 250 also includes storage and a processor as discussed in connection with the first ISP 202. The first ISP 202 and the second ISP 250 include a router/gateway 224 and 256, respectively. Detailed explanations on other structural elements of the first ISP 202 and the second ISP 250 are limited to the extent that is needed for description of the present invention.

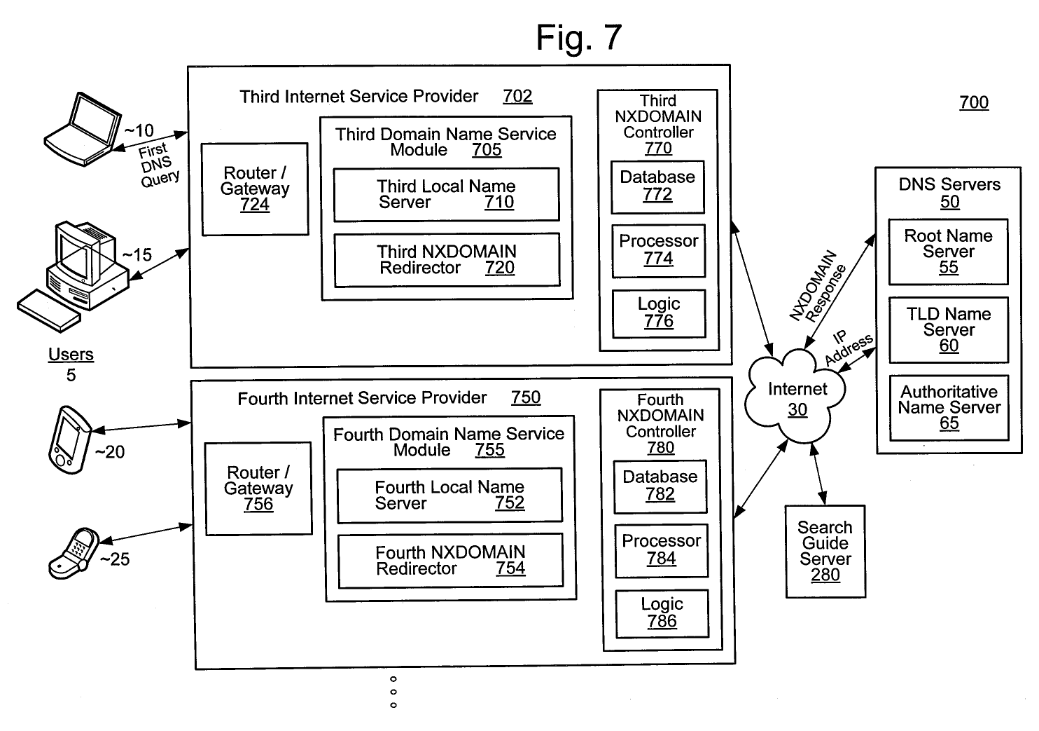

In FIG. 2, a NXDOMAIN controller 270 is present at a network location independent of locations of the first ISP 202 and the second ISP 250. Alternatively, the NXDOMAIN controller 270 may be consolidated into the first ISP 200 or the second ISP 250, as will be described in detail in conjunction with FIG. 7 later. The NXDOMAIN controller 270 may include one or more servers that implement individual assigned functions and services. The NXDOMAIN controller 270 includes a database 272, a processor 274 and logic 276. The database 272 stores various information required for operation of the NXDOMAIN controller 270, which will be described later. The processor 274 operates to control the database 272 and the logic 276. The logic 276 performs selected functions, e.g., how to determine an optimal search guide server. As an input, the logic 276 may obtain IP addresses of the first and the second local name servers 210 and 252 and a domain name queried by the users 5. As an output, the logic 276 may generate information of the optimal search guide server. To perform the selected functions, the logic 276 operates to determine a network distance between the optimal search guide server and the users 5. The logic 276 further operates to determine whether the optimal search guide server stores information relevant to the domain name queried by the users 5. For instance, when a domain name is tttoyplace.com, the logic 276 may determine that the users 5 are interested in toys and locates the optimal search guide server having toy information.

The NXDOMAIN controller 270 operates cooperatively with the first ISP 202 and the second ISP 250. The NXDOMAIN controller 270 may be in communication with the first ISP 202 and/or the second ISP 250 and collects information relating to how to handle non-existing domain requests. In one example, a business entity that operates the NXDOMAIN controller 270 may have a contractual arrangement with the first ISP 202 and/or the second ISP 250. In another example, the business entity that operates the NXDOMAIN controller 270 may coincide with the first ISP 202, the second ISP 250, or both. The NXDOMAIN controller 270 may store in the database 272 detailed information as to how to handle the non-existing domain requests received at the first ISP 202 and the second ISP 250. The NXDOMAIN controller 270 may store in the database 272 an IP address of a search guide server 280 which will provide landing pages to the users 5. Landing pages include access to services and information that may correlate with and/or may be equivalent to the request initially sought by the users 5. The landing pages also may provide useful search results, advertisements, etc. Such alternative services and information may be offered on the landing pages by participant servers. The participant servers engage in advertising their services and information through contractual arrangement with the first and the second ISPs 202 and 250, the NXDOMAIN controller 270, or both.

The NXDOMAIN controller 270 also may store in the database 272 criteria that determine an optimal search guide server in response to the non-existing domain requests from the users 5. The optimal search guide server indicates a best search guide server, for example, which stores relevant content that the users 5 are interested and which is located proximate to the users 5 to provide alternative responses to the non-existing domain request. As one example, the NXDOMAIN controller 270 may store a network location of the search guide server 280, availability of the search guide server 280, content stored in the search guide server 280, etc. Thus, the NXDOMAIN controller 270 may determine whether the search guide server 280 stores the relevant content and is available and proximate to the users 5, and select the search guide server 280 as the optimal search guide server. The NXDOMAIN controller 270 can be constructed out of any suitable hardware and software. Alternatively or additionally, the NXDOMAIN controller 270 may be constructed with special hardware and/or software if needed.

The search guide server 280 stores the landing pages for providing useful information and services. FIG. 2 shows one search guide server 280, but two or more search guide servers 280 may be distributed throughout the network. The search guide server 280 may be implemented with a web server and process web requests from the users 5. The search guide server 280 may receive a Hypertext Transfer Protocol (HTTP) request, but the search guide server 280 may receive and process requests in different protocols. Preferably, the search guide server 280 may be located proximate to the users 5, thereby to improve a response speed.

Upon receipt of requests from the users 5, the search guide server 280 may respond and return to the users 5 landing pages, e.g., including multiple hyperlinks to the participant servers, useful information and search suggestions relevant to the initial non-existing domain. In another embodiment, the search guide server 280 may redirect the requests from the users 5 to other search guide servers when the redirection serves better the requests by the users 5. For instance, the search guide server 280 may find other search guide servers having more relevant content. Namely, the search guide server 280 may refine suggestions or guidance by redirecting the requests to other search guide servers. The refinement performed at the search guide sever level may improve accuracy of the landing pages and maximize use of the landing pages, which may increase revenue. In addition, a level of user satisfaction may improve.

In the first ISP 202 and the second ISP 250, the network address translation (NAT) technique may be set up at the router or gateway 224 and 256. More specifically, the router or gateway 224 and 256 may be set up to direct all of the domain name response packets to the first and the second NXDOMAIN redirector 220 and 254. Alternatively, the NAT setup may be made at the local name servers 210 and 252.

In FIG. 2, the NXDOMAIN controller 270 may provide a centralized control over the non-existing domain requests from the first ISP 202 and the second ISP 250. Preferably, the network location of the NXDOMAIN controller 270 is independent of that of the first and the second ISPs 202 and 250. The search guide server 280 may be controlled by the NXDOMAIN controller 270. In response to the non-existing domain requests, the NXDOMAIN controller 270 guides the users 5 to the search guide server 280 operable to offer alternative responses which provide the best suggestions and guidance to the users 5.

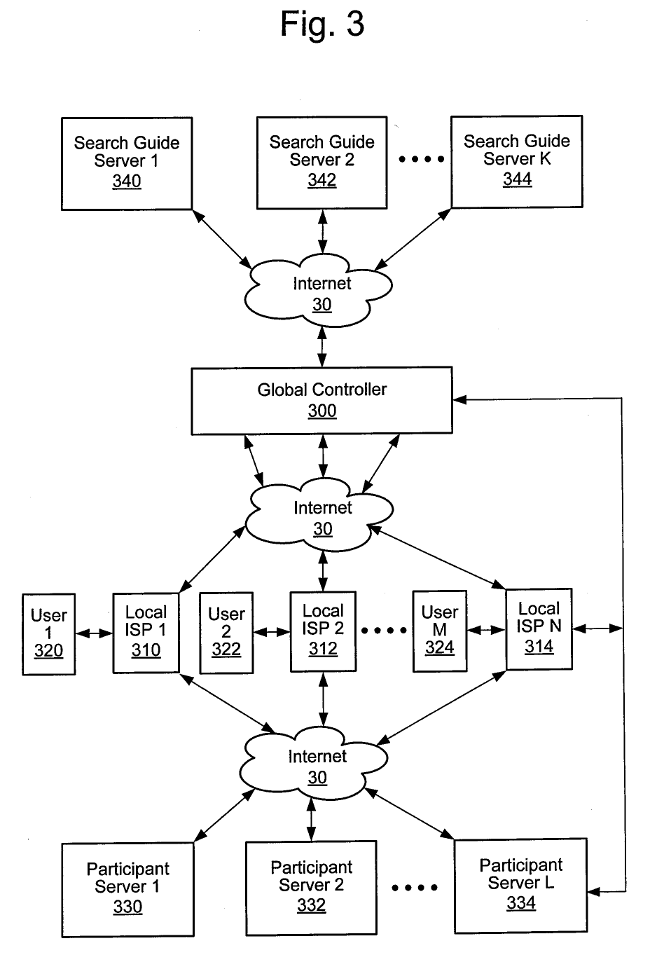

In FIG. 2, the NXDOMAIN controller 270 operates with the first and the second ISPs 202 and 250. In another embodiment, the non-existing domain request may be controlled on a global scale. FIG. 3 is a block diagram illustrating control structure of a global NXDOMAIN controller (“the global controller”) 300. In FIG. 3, the global controller 300 cooperatively operates with a plurality of ISPs including Local ISP 1 310, Local ISP 2 312 . . . Local ISP N 314. As one example, the multiple ISPs 310, 312 . . . 314 may subscribe to services offered by the global controller 300. The global controller 300 and the plurality of ISPs 310, 312 . . . 314 may be operated by a single entity, or may have contractual arrangements among them.

The global controller 300 may control and communicate with multiple search guide servers 340, 342, 344 which are, respectively, a search guide server 1, a search guide server 2 and a search guide server K. The multiple search guide servers store landing pages which contain suggestions and guidance to users. Multiple participant servers including Participant server 1 (330), Participant Server 2 (332) and Participant L (334) are actual servers which provide internet services to users. The multiple participant servers may advertise their services through the multiple ISPs and/or the global controller 300, thereby to attract users to use their services and to invite users to use their services.

In FIG. 3, users include a first user group 320, a second user group 322 and an M^{th} user group 324. The first Local ISP 310 provides the internet connection to the first user group 320, the second Local ISP 312 provides the internet connection to the second user group 332 and the N^{th} Local ISP 314 provides the connection to the M^{th} user group 324. The local ISP1 310 to local ISPN 314 sends one or more DNS queries directed to the non-existing domain to the global controller 300. The global controller 300 provides information of search guide servers which are operable to supply alternative responses such as landing pages. The local ISP1 310˜local ISPN 314 receive the information of the search guide servers 340, 342 . . . 344 from the global controller 300 and forward the information to user 1 320, user 2 322, user M 324, etc. As a result, user 1 320, user 2 322, user M 324, etc. may use the landing pages provided by the search guide servers 340, 342 . . . 344. Instead of relying on the landing pages, the users may send their requests to Participant Server 1, Participant Server 2 and/or Participant Server N. As shown in FIG. 3, requests of the user groups 320, 322 and 324 are forwarded to the global controller 300 through the multiple local ISPs 310, 312 and 314. The global controller 300 globally, i.e., instead of locally, controls the internet traffic directed to the non-existing domains in a centralized manner rather than by individual control at the ISP level. More specifically, the global controller 300 directs the non-existing domain requests from the multiple user groups 320, 322 and 324 to the multiple search guide servers 340, 342 and 344 which are controlled by the global controller 300. The global controller 300 may monitor and evaluate the multiple search guide servers 340, 342 and 344 and coordinate their operations. Eventually, the non-existing domain requests by the multiple user groups 300, 322 and 324 may take advantage of suggestions and/or guidance provided by the multiple search guide servers 340, 342 and 344.

As shown in FIG. 3, the global controller 300 may take over the control performed at the level of the local IPS. At least for that reason, the global controller 300 may collect, update and refine search guide information available at the multiple search guide servers 340, 342 and 344. The global controller 300 may also implement high level logic to improve a frequency of usage of the landing pages. The high level logic may also evaluate and update a user preference by using statistical information, a user survey, history of user selections, etc. For instance, the global controller 300 may collect and store historical information with regard to the frequency of the user selection on the suggestions and/or guidance and complaints by the user. The global controller 300 may refine the suggestions and the guidance. The global controller 300 may update the database on a real time basis, thereby to quickly and accurately accommodate change in the user response.

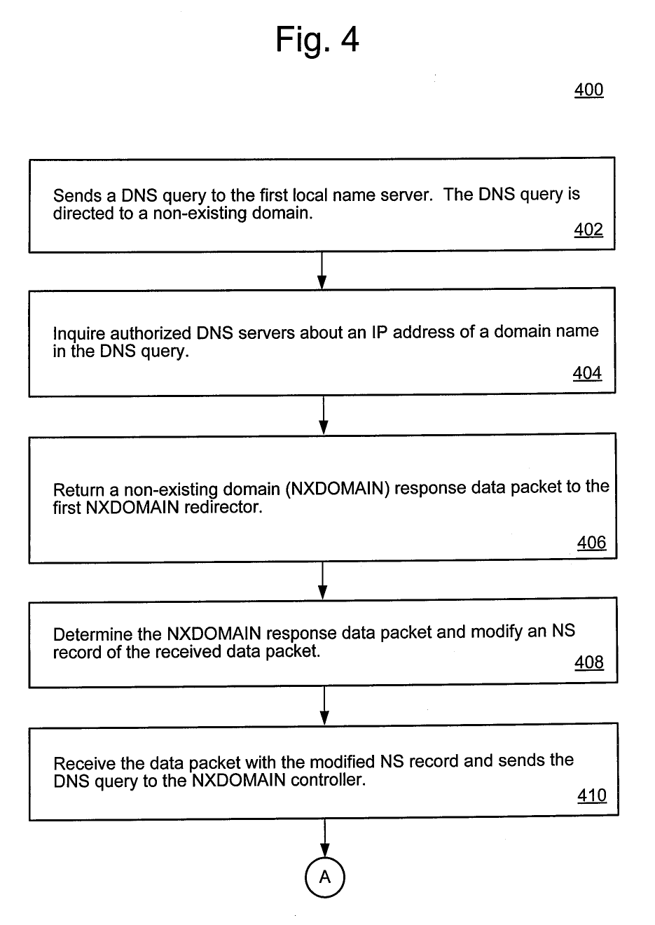

Referring to FIG. 4, operations of the internet traffic control system 200 in FIG. 2 are described in detail. FIG. 4 is a flow chart illustrating operations of the internet traffic control system 200 and one embodiment of an internet traffic control method 400. In this embodiment, the user 10 sends a DNS query to the first ISP 202 and the first local name server 210 of the first ISP 202 receives the DNS query (block 402). The DNS query is directed to a non-existing domain. For example, when the user 10 types a selected domain name in an URL section of an internet browser, the browser automatically send the DNS query to the first local name server 210 of the first ISP 202 which provides the internet connection. The first ISP 202 operates and controls the first local name server 210. At block 404, the first local name server 210 inquires authorized DNS servers 50 such as the root name server, the TLD name server and/or the authorized name server about an IP address of the DNS query by the user 10.

The DNS servers 50 return a domain name resolution response to the first ISP 202 at block 406. The domain name resolution response includes a data packet that indicates a non-existing domain. The data packet includes a predetermined value that indicates the non-existing domain in accordance with the internet data packet convention. The router/gateway 224 receives the data packet indicative of the non-existing domain at block 406. The router/gateway 224 may be set up to forward the data packet to the first NXDOMAIN redirector 220. The router/gateway 224 may be set up with the NAT technique, thereby to modify a destination address of the non-existing domain response data packet with that of the first NXDOMAIN redirector 220.

At block 408, the first NXDOMAIN redirector 220 receives the non-existing domain response and modifies a name server (“NS”) record of the non-existing domain response. Specifically, the first NXDOMAIN redirector 220 adds an IP address of the NXDOMAIN controller 270 to an NS record section. On the other hand, the first NXDOMAIN redirector 220 forwards a data packet from the DNS servers 50 to the first local name server 210 without any modification when it is determined that the data packet indicates an existing domain name response.

Subsequent to modification to the NS record of the data packet, the first NXDOMAIN redirector 220 transmits the data packet to the first local name server 210. At block 410, the first local name server 210 receives the data packet with the IP address of the NXDOMAIN controller 270. The first local name server 210 may consider the NXDOMAIN controller 270 as an authoritative name server and sends the DNS query to the NXDOMAIN controller 270 for the domain name resolution. In other words, based on the modified NS record, the first local name server 210 inquires the NXDOMAIN controller 270 about the DNS query as if the NXDOMAIN controller 270 is one of the authorized DNS servers 50 (block 410).

As described in conjunction with block 408, the first local name server 220 receives the domain name response for the existing domain request from the first NXDOMAIN redirector 220. For instance, the first local name server 220 returns to the user 10 an IP address of the existing domain name which is contained in the domain name response from the DNS servers 50. The user 10 receives the IP address and sends an internet request to a server having the returned IP address. The user 10 receives a requested service and/or information from the server having the returned IP address.

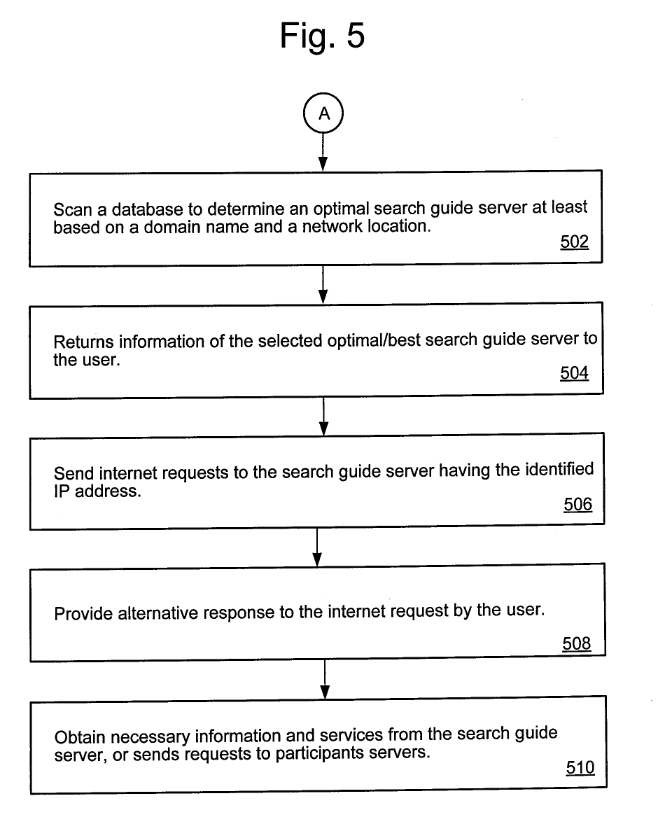

Referring to FIG. 5, operations of the NXDOMAIN controller 270 are further explained. FIG. 5 is a flow chart illustrating operations performed by the NXDOMAIN controller 270. As described in conjunction with FIG. 4, the NXDOMAIN controller 270 receives the DNS query from the first local name server 210 (block 410). The NXDOMAIN controller 270 scans the database 272 to locate an IP address of an optimal search guide server. The optimal search guide server is operable to provide landing pages with the best suggestions and guidance as well as having a close proximity to the network location of the user 10. In response to the domain name of the DNS query and the IP address of the first local name server 210, the logic 276 determines relevant content initially sought by the user 10 and the network location (block 502). For instance, the domain name of the DNS query may include a typographical error of an online toy store name. The logic 276 receives the misspelled domain name, evaluates the domain name and determines that the user 10 is interested in a toy. Based on the determination on the content, the NXDOMAIN controller 270 is able to determine which search guide servers may serve landing pages with the content that is relevant to a toy (block 502). Furthermore, the NXDOMAIN controller 270 also determines the network proximity between the optimal search guide server and the user 10 and availability of the optimal search guide server (block 502).

The NXDOMAIN controller 270 may monitor the search guide server 280 to determine the availability and current information stored in the search guides server 280. Based on criteria specifying the optimal search guide server and the real-time monitoring information, the NXDOMAIN controller 270 is able to determine a best search guide server. In this embodiment, the best search guide server corresponds to the search guide server 280 only for convenience of explanation. The NXDOMAIN controller 270 returns information of the search guide server 280 such as the IP address of the search guide server 280 to the first local name server 210 (block 504). The NXDOMAIN controller 270 operates in the same manner that an authoritative name server such as the authoritative name server 65 operates. In other words, the NXDOMAIN controller 270 stores in the database 272 the IP address mapped to the search guide server 280. The first local name server 210 receives the domain name response from the NXDOMAIN controller 270 and forwards the response to the user 10 (block 504). Upon receipt of the domain name response, the user 10 sends an internet request to the search guide server 280 at block 506. The internet request includes, for example, an HTTP request that includes a full Universal Resource Locator (“URL”) of the initial DNS query.

In this embodiment, the search guide server 280 may be a web server that processes a web request. The search guide server 280 may provide the user 10 with a web page that includes various suggestions and guidance based on the internet request by the user 10 (block 508). Alternatively, or additionally, the search guide server 280 may redirect the request by the user 10 to another search guide server which may store more relevant content to the initial request by the user 10. Namely, the search guide server 280 may refine a resultant landing page by redirecting the request by the user to another search guide server equipped with better content. As the search guide server 280 receives the full URL from the user 10, the search guide server 280 is able to determine more relevant content of the initial internet request by the user 10. For instance, while the NXDOMAIN controller 270 may determine that the initial internet request by the user 10 is related to toys based on the domain name, the search guide server 280 may determine that the initial DNS query is related to toy cars. At block 510, the user 10 receives search guide web pages from the search guide server 280 or another search guide server. In one embodiment, the search guide web pages include various hyperlinks that direct the user 10 to participant servers operable to provide alternative services and/or information to the ones initially requested by the user 10 (block 510). When the user 10 selects one of the hyperlinks, revenue may be generated for the operating entity of the NXDOMAIN controller 270 as well as the first ISP 202. In another embodiment, the search guide web pages include information that the user 10 is initially searching, and the user 10 may obtain all of the information from the search guide web pages. In yet another embodiment, the search guide web pages include useful search guide and information, advertisements, etc. Revenue may generate solely based on the use of the search guide web pages.

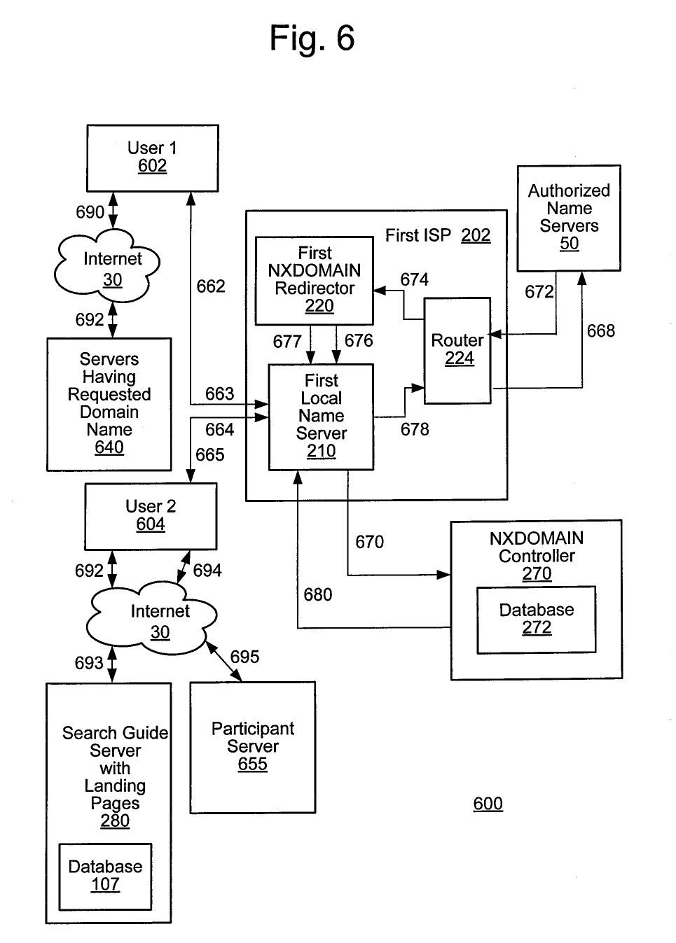

Referring to FIG. 6, signal flows of the internet traffic control system 200 are explained. FIG. 6 is a block diagram illustrating signal flows of the non-existing domain traffic control. In FIG. 6, operations of the first ISP 202 are described only for convenience of explanation. FIG. 6 illustrates domain name resolution of both the non-existing domain request and an existing domain request. User 1 602 sends a first DNS query 663 to the first local name server 210 of the first ISP 202 (flow 663). User 2 604 sends a second DNS query 664 to the first local name server 210 (flow 664). The first local name server 210 receives the first and the second DNS queries 663 and 664 and asks authorized name servers 50 to resolve the first and the second DNS queries 663 and 664 through the router/gateway 224 (flows 678 and 668). The authorized name servers 50 return a domain name resolution response 672 to the router/gateway 224. The router 224 forwards the domain name resolution response 672 to the first NXDOMAIN redirector 220 (flow 674). The first NXDOMAIN redirector 220 intercepts the domain name resolution response 672 (flow 674) and the first local name server 210 may not directly receive the domain name resolution response (flow 674).

The first NXDOMAIN redirector 220 determines whether the domain name resolution response 674 includes the non-existing domain response or an existing domain name response including a resolved IP address. Specifically, the first NXDOMAIN redirector 220 detects whether the domain name resolution response 674 includes a predetermined value indicating the non-existing domain response or the existing-domain response, e.g., including the resolved IP address. The first NXDOMAIN redirector 220 modifies an NS record of the non-existing domain response by adding information of the NXDOMAIN controller 270. In this embodiment, the first DNS query 663 includes the existing domain request and the second DNS query 664 includes the non-existing domain request. The first NXDOMAIN redirector 220 forwards to the first local name server 210 a data packet of the existing domain name response to the first DNS query 663 (flow 676). On the other hand, the first NXDOMAIN redirector 220 modifies a data packet of the non-existing domain response to the second DNS query 664 by changing the NS record of the data packet. The modified data packet 677 is forwarded to the first local name server 210 (flow 677).

The first local name server 210 forwards to the user 1 602 a first domain name response including the data packet of the existing domain name response (flow 662). The user 1 602 receives the first domain name response (flow 662) and subsequently sends an internet request to a server 640 identified by the returned first domain name response (flow 690). On the other hand, the first local name server 210 forwards to the NXDOMAIN controller 270 a DNS query based on a modified NS record when a second domain name response includes the data packet the non-existing domain response (flow 670). The NXDOMAIN controller 270 receives the second DNS query including the modified NS record (flow 670) and determines a best search guide server based on predetermined criteria and real time information of a search guide server status. The predetermined criteria may be defined at least by the domain name of the second DNS query. The predetermined criteria may be stored in the database 272 and the real time information may be collected by communicating with the first ISP 202 and other ISPs (not shown) across the internet.

The NXDOMAIN controller 270 sends the first local name server 210 the second domain name response to the second DNS query (flow 680). The first local name server 210 provides the second domain name response including the IP address of the search guide server 280 to the user 2 604 (flow 665). The user 2 604 sends an internet request such as an HTTP request to the search guide server 280 based on the returned first domain name response (flow 692). The search guide server 280 provides a selected landing page with suggestions and guidance. As one example, the user 2 604 receives information and services provided by various domain names preferably including information and services provided by a correct domain name of the second DNS query (flows 692 and 693). As another example, hyperlinks that contain information pertaining to the initial internet request by the user 2 604 may be provided on the landing page (flow 693). The user 2 604 clicks one of the hyperlinks and sends the request to a participant server 655 selected by clicking on the hyperlink (flow 694). The participant server 655 receives the request from the user 2 604 and provides the requested service and/or information (flow 695).

As shown in FIG. 6, the NXDOMAIN controller 270 operates to control the non-existing domain traffic received at the first local ISP 202. The NXDOMAIN controller 270 may communicate with other local ISPs and be able to control the non-existing domain traffic. Accordingly, the non-existing domain traffic may be controlled in the centralized manner rather than an individual IPS level. The centralized control may facilitate more organized and uniform control over the non-existing domain traffic. For instance, the NXDOMAIN controller 270 may collect search guide server information from multiple local ISPs and integrate the server information in real time. Users may be directed to more available and resourceful alternatives instead of a simple error page with regard to the non-existing domain requests. Satisfaction level of users may increase, thereby resulting increase in revenue.

The centralized control over the non-existing domain traffic described above modifies the NS record and redirects the DNS query based on the modified NS record. This may allow the first and the second local name servers 210 and 252 to cache the domain name response from the NXDOMAIN controller 270. In another embodiment, the local name servers 210 and 252 may or may not cache the domain name response. Caching at the first and the second local name servers 210 and 252 may improve the response speed and efficiency of the local ISPs. Additionally, caching at the local name server may be applicable to requests for a sub-level domain of the non-existing domain. For instance, a DNS query for aaa.eeexample.com, the domain is processed as a non-existing domain request and an NS record of a non-existing domain response is modified to be directed to the NXDOMAIN controller 270, as described in conjunction with FIG. 6. With regard to another DNS query for a sub-level domain of the non-existing domain, e.g., bbb.eeexample.com, the modified NS record of the domain, eeexample.com may be already cached. Thus, the DNS query for bbb.eeexample.com may be directly sent to the NXDOMAIN controller 270, thereby to improve a response speed.

FIG. 7 is a block diagram illustrating another embodiment of an internet traffic control system 700 for a non-existing domain. The system 700 includes the users 5 including various users 10, 15, 20 and 25 and the DNS servers 50 which are described above in conjunction with FIG. 2. The system 700 includes a third ISP 702 and a fourth ISP 750. In this embodiment, the third ISP 702 provides the internet connection to the users 10 and 15. The fourth ISP 750 provides the internet connection to the users 20 and 25. The third ISP 702 includes a third domain name service module 705 which houses a third local name server 710 and a third NXDOMAIN redirector 720 and a router/gateway 724. The third ISP 702 also includes a third NXDOMAIN controller 770. Likewise, the fourth ISP 750 includes a fourth domain name service module 755 which houses a fourth local name server 752 and a fourth NXDOMAIN redirector 754 and a router/gateway 756. Although not shown in FIG. 7, each ISP includes processors, storage and any other hardware required for operation of the ISP.

In the third ISP 702 and the fourth ISP 750, the third NXDOMAIN controller 770 and the fourth NXDOMAIN controller 780 may be under the control of the third ISP 720 and the fourth ISP 750, respectively. The domain name service modules 705 and 755 may integrate the third and the fourth local name servers 710 and 752 with the third and the fourth NXDOMAIN redirectors 720 and 754, respectively. Accordingly, the third and fourth domain name server modules 705 and 755 operate to receive a domain name response data packet and modify a selected record of the data packet if needed. The NXDOMAIN controllers 770 and 780 may be assigned to the third ISP 702 and the fourth ISP 750, respectively. Alternatively, or additionally, the NXDOMAIN controllers 770 and 780 may control the non-existing domain requests incoming from other ISPs having no assigned NXDOMAIN controller. In that case, the NXDOMAIN controllers 770 and 780 may perform a centralized control over the non-existing domain request from other ISPs, although the NXDOMAIN controllers 770 and 780 locally reside in the third and the fourth ISPs 720 and 750.

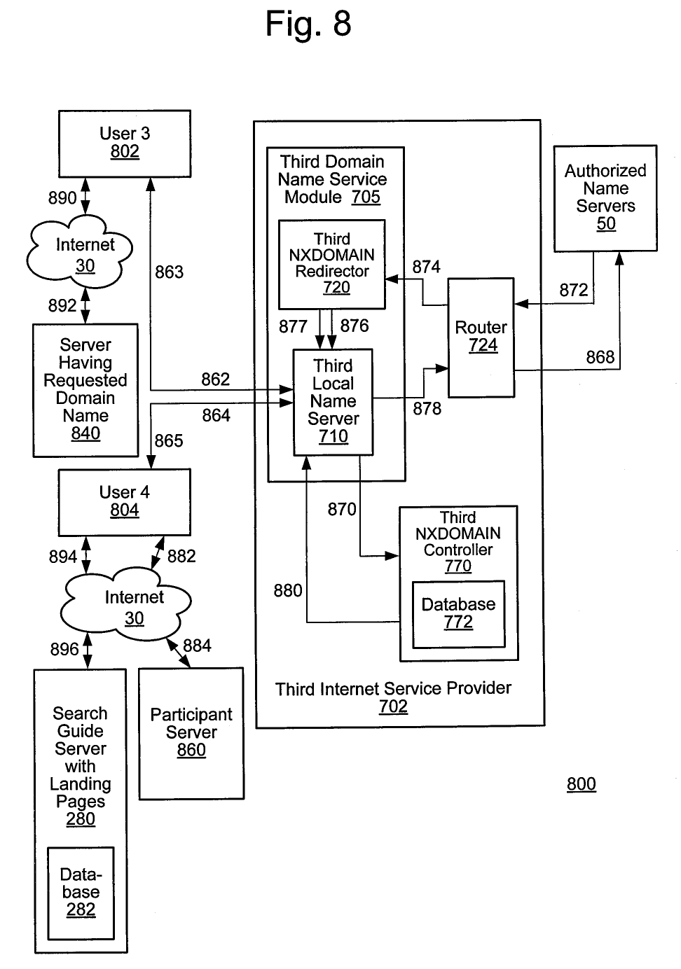

Referring to FIG. 8, signal flows and operations of the internet traffic control system 700 are explained in detail. FIG. 8 is a block diagram illustrating signal flows of the non-existing domain traffic control of the system 700 in FIG. 7. In FIG. 8, operations of the third ISP 702 are described only for convenience of discussion. A user 3 802 sends a third DNS query 862 to the third ISP 702. The third domain name service module 705 receives the third DNS query 862. As a result, the third local name server 710 receives the third DNS query 862 and inquires the authorized name servers 50 through the router 724 (flows 868 and 878). The authorized name servers 50 return a data packet of a domain name response (flow 872) to the router 724 which in turn forwards the data packet to the third domain name service module 705. The third NXDOMAIN redirector 720 receives the data packet (flow 874). The third NXDOMAIN redirector 720 determines that the data packet indicates an existing domain name response such as a resolved IP address. The third NXDOMAIN redirector 720 passes the data packet having the existing domain name response to the third local name server 710 (flow 876), which forwards the data packet to the user 3 802 (flow 863). The user 3 802 sends an internet request to a server 840 identified by the returned data packet (flow 890) through the third internet service provider 702. The server 840 will respond to the internet request from the user 3 802 (flow 892).

A user 4 804 sends a fourth DNS query (flow 864) requesting a resolution of a non-existing domain. The third domain name service module 705 receives the fourth DNS query (flow 864) and the third local name server 710 sends the fourth DNS query to the authorized name servers 50 through the router 724 (flows 868 and 878). The authorized name servers 50 returns a data packet indicating the non-existing domain to the third domain name service module 705 through the router 724 (flows 872 and 874). The third NXDOMAIN redirector 720 receives the data packet (flow 874). The third NXDOMAIN redirector 720 determines that the data packet indicates the non-existing domain response. The third NXDOMAIN redirector 720 modifies the data packet such that the third local name server 710 inquires the NXDOMAIN controller 770 about information of the search guide server 280 such as the IP address. The third NXDOMAIN redirector 720 forwards the modified data packet to the third local name server 710 (flow 877), which sends the fourth DNS query to the NXDOMAIN controller 770 (flow 870).

The NXDOMAIN controller 770 receives the fourth DNS query (flow 870) and determines a best search guide server which is operable to provide a landing page. The NXDOMAIN controller 770 may be aware of the content of the initial domain name request by the user 4 804 based on an input of the initial domain name of the fourth DNS query. The NXDOMAIN controller 770 also may determine network proximity of available search guide servers to the user 4 804. The NXDOMAIN controller 770 returns information of the best search guide server 280 such as an IP address to the third local name server 710 (flow 880), which in turns returns the information to the user 4 804 (flow 865). The user 4 804 sends an internet request to the search guide server 280 based on the returned information of the search guide server 280 (flow 894) and the search guide server 280 provides a selected landing page (flow 896). The user 4 804 subsequently reviews and/or selects information and services on the selected landing page (flow 882). Alternatively, or additionally, a participant server corresponding to the selected information responds to the request from the user 4 804 (flow 884).

In this embodiment, the NXDOMAIN controller 770 operates with and is controlled by the local ISP such as the third ISP 702. The non-existing domain request may be internally processed by the residing NXDOMAIN controller 770 and the response speed may improve. The NXDOMAIN controller 770 may collect more accurate and relevant information for the network location in which the local ISP serves. Accordingly, user satisfaction level may improve when the user finds accurate suggestions and guidance by the landing page. In addition, the third local name server 710 of the local ISP may cache the domain name response which may further enable efficient and speedy response. In another embodiment, the third local name server 710 may or may not cache the domain name response. Additionally, the NXDOMAIN controller 770 may serve as the assigned NXDOMAIN controller for the local ISP and an independent controller for other ISPs having no assigned NXDOMAIN controller, as shown in FIGS. 2-3, for example. Thus, the NXDOMAIN controller 770 may control the non-existing domain traffic locally and globally.

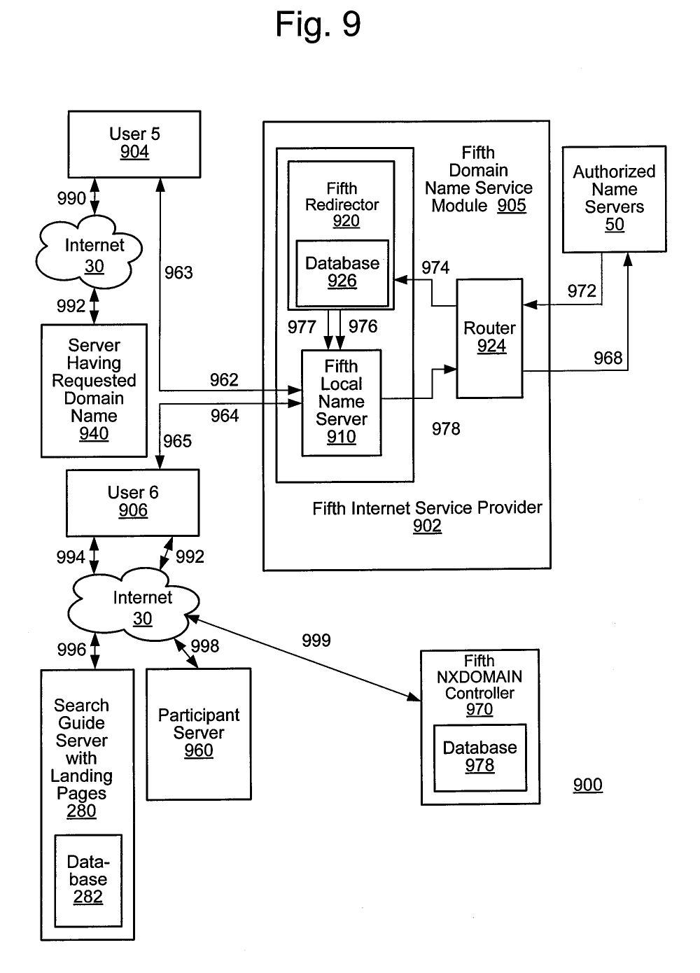

FIG. 9 is a block diagram illustrating another embodiment of an internet traffic control system 900 directed to the non-existing domain name and signal flows of the internet traffic. The internet traffic control system 900 includes a fifth ISP 902 and a fifth NXDOMAIN controller 970. The fifth ISP 902 includes a fifth domain name service module 905 and a router 924. The fifth domain name service module 905 includes a fifth local name server 910 and a fifth NXDOMAIN redirector 920 having a database 926. In this embodiment, the database 926 may store information of the search guide server 280 with landing pages.

A user 5 904 sends a DNS query to the fifth ISP 902 (flow 962). At the fifth domain name service module 905 receives the DNS query and the fifth local name server 910 sends the DNS query to the authorized name servers 50 through the router 924 (flows 968 and 978). The authorized name server 50 returns a response data packet indicating an existing domain name response to the fifth domain name service module 905 through the router 924 (flows 972 and 974). The fifth local name server 910 receives the response data packet of the existing domain name response from the fifth NXDOMAIN redirector 920 (flow 976) and returns the response data packet to the user 1 802 (flow 963).

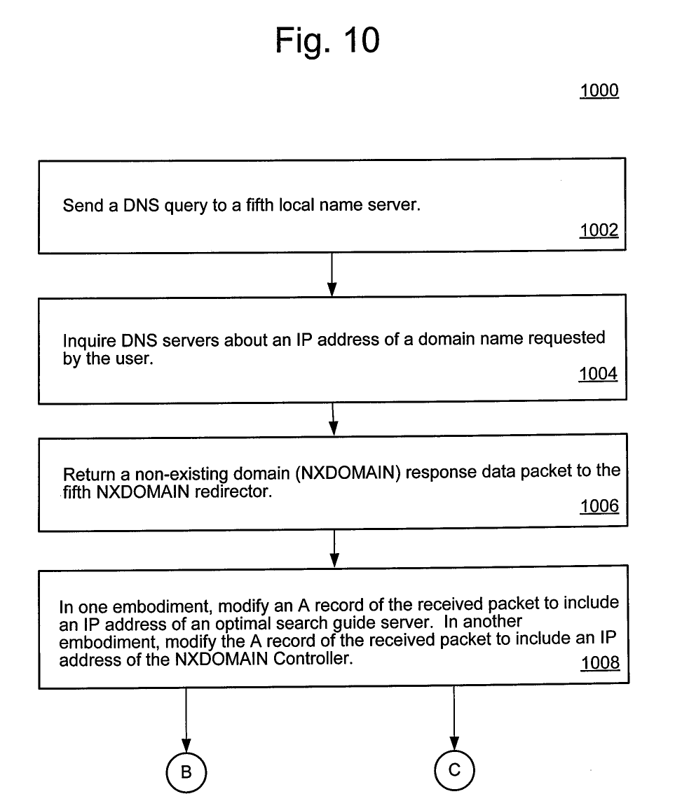

On the other hand, a user 6 906 sends another DNS query to the fifth ISP 906 (flow 964). Another DNS query is directed to a non-existing domain. Referring to FIG. 10, processing of another DNS query directed to the non-existing domain is further explained. The fifth DNS module 905 receives the DNS query (flow 964) at block 1002 and the fifth local name server 910 sends the DNS query to the authorized name servers 50 through the router 924 (flows 968 and 978) at block 1004. The authorize name server 50 returns a response data packet indicating the non-existing domain response to the fifth DNS module 905 through the router 924 (flows 972 and 974) at block 1006. The fifth NXDOMAIN redirector 920 receives the response data packet and determines that the response data packet corresponds to the non-existing domain response at block 1006. In this embodiment, an A record of the response data packet is modified at block 1008. In the previously described embodiments, the NS record of the response data packet is modified. In one embodiment, the A record of the response data packet may be modified to include an IP address of an optimal search guide server (block 1008). In another embodiment, the A record of the response data packet may be modified to include an IP address of the NXDOMAIN controller 970 (block 1008).

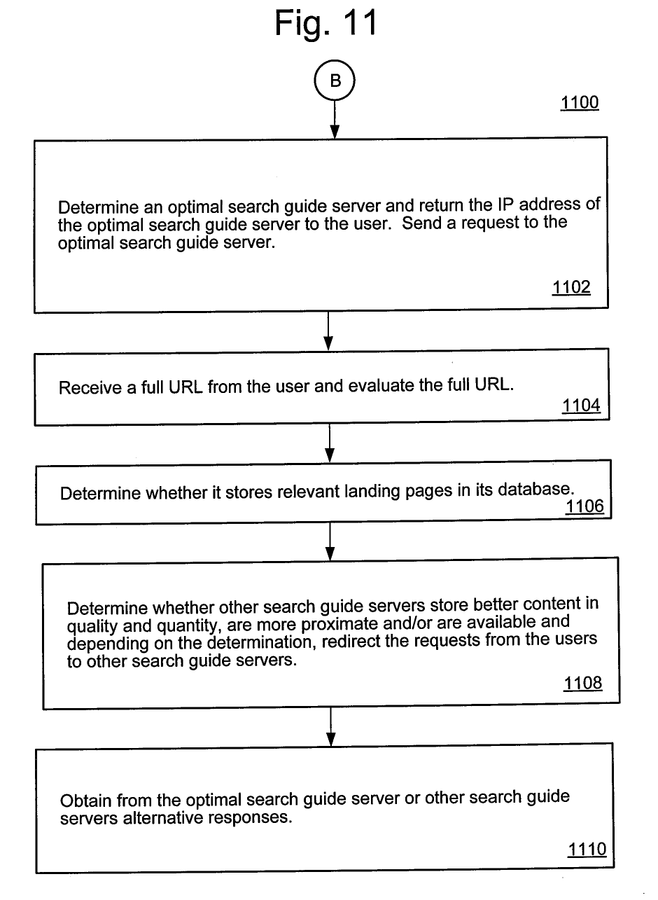

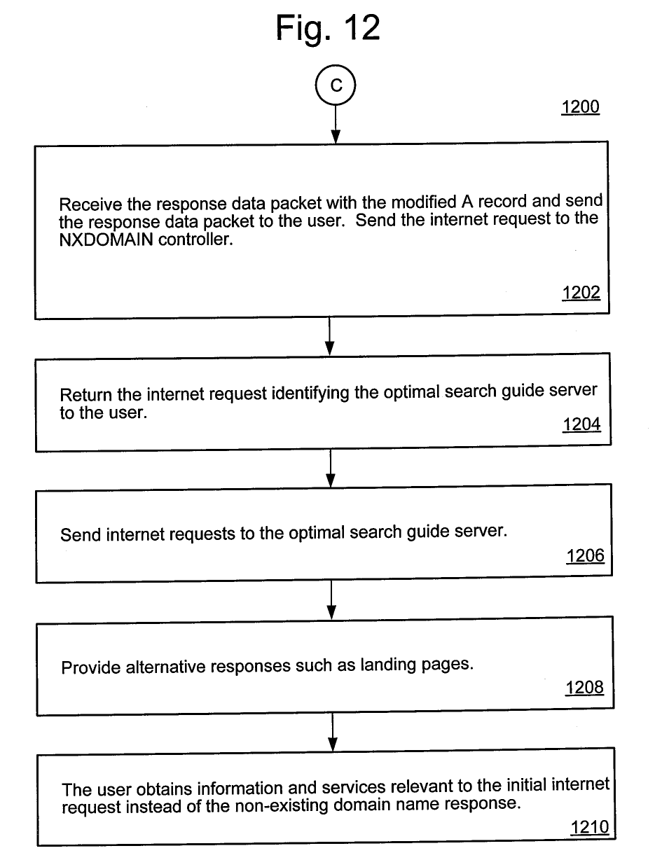

Referring to FIGS. 11-12, operations of the internet traffic control system for modifying the A record are explained in detail. FIGS. 11 and 12 are flow charts illustrating two embodiments of a non-existing domain traffic control method. FIG. 11 illustrates the embodiment of modifying the A record of the response data packet with the IP address of the optimal search guide server. The database 926 of the fifth NXDOMAIN redirector 920 stores the IP address of search guide servers. For convenience of explanation, the fifth NXDOMAIN redirector 920 stores in the database 926 the IP address of the search guide server 280. The fifth NXDOMAIN redirector 920 also stores in the database 926 predetermined criteria of determining the optimal search guide server. The predetermined criteria are defined by whether a search guide server stores relevant content to the initial DNS query. As one example, the fifth NXDOMAIN redirector 920 determines content relevant to a domain name initially sought by the user 6 906, such as tttoyplace.com. Then, the fifth NXDOMAIN redirector 920 determines which search guide server stores the relevant content. As a result, the fifth NXDOMAIN redirector 920 determines that the search guide server 280 is the optimal search guide server at block 1102. At block 1102, the fifth local name server 910 returns the data packet with the modified A record of the optimal search guide server to the fifth local name server 910, which in turn forwards the response data packet with the modified A record to the user 6 906(flow 965). By way of example only, the modified A record of the optimal search guide server includes the IP address of the search guide server 280 at block 1102.

At block 1104, the search guide server 280 receives a request from the user 6 906. At this time, the search guide server 280 may obtain a full URL from the user 6 906. At block 1104, the search guide server 280 evaluates the full URL and is able to determine whether it stores relevant landing pages in the database 282 based on the evaluation of the full URL. At block 1108, the search guide server 280 is also able to determine whether other search guide servers may store better landing pages. The search guide server 280 may redirect the request of the user 6 906 to other search guide servers having better landing pages. At block 1110, the user 6 906 may obtain the landing pages having relevant information and services from the search guide server 280 or other search guide servers that store better landing pages.

In the embodiment described in conjunction with FIGS. 9-11, the non-existing domain request may be controlled by modifying the A record of the response data packet. To modify the A record with the IP address of the optimal search guide server, the fifth NXDOMAIN redirector 920 may be equipped with the functions for determining the optimal search guide server and storing the IP address of the optimal search guide server. To some extent, the fifth NXDOMAIN redirector 920 may perform a selected function of the NXDOMAIN controller 270 described in conjunction with FIGS. 2 and 4-6. In the embodiment of FIGS. 9-11, the fifth NXDOMAIN redirector modifies the A record and the internet traffic directed to the non-existing domain may be controlled without involvement of the NXDOMAIN controller 970. The NXDOMAIN controller 970 is used to implement the non-existing domain traffic control method of FIG. 12.

FIG. 12 illustrates another embodiment of modifying the A record of the response data packet. At block 1202, the A record of the response data packet is modified with the IP address of the fifth NXDOMAIN controller 970 and the fifth local name server 910 receives the response data packet. The fifth local name server 910 sends the response data packet to the user 6 906 (block 1202). The fifth redirector 920 receives the response data packet and modifies the A record. Subsequent to the modification of the A record, the fifth NXDOMAIN redirector 920 sends the response data packet to the fifth local name server 910 (flow 977 in FIG. 9). The fifth local name server 910 returns the response data packet to the user 6 906 as the A record has been modified (flow 965). The user 6 906 sends a request to the NXDOMAIN controller 970 based on the A record at block 1202. The NXDOMAIN controller 970 receives the request and returns information identifying the best search guide server 280 to the user 6 906 (block 1204). The best search guide server 280 by the NXDOMAIN controller 970 is selected by an application level redirection rather than resolving a DNS. For example, an HTTP redirection may be used to redirect the user request from the NXDOMAIN controller 970 to the best search guide server. At block 1206, the user 6 906 sends a request to the search guide server 280 and at block 1208, the best search guide server (280 in this embodiment) responds to the user 6 906 by providing landing pages. At block 1210, the user 6 906 obtains information from the landing pages.

As described above in conjunction with FIGS. 9-12, the internet traffic control system 900 may control the non-existing domain traffic by modifying the A record of the response data packet with either the IP address of the best search guide server or the IP address of the centralized NXDOMAIN controller operable to provide the information of the best search guide server. Instead of the modification on the NS record, the A record is modified by the fifth NXDOMAIN redirector 920. Accordingly, the user 6 904 receives the response data packet subsequent to the modification. In addition, the A record is modified before the fifth local name server 910 receives the response data packet. The fifth local name server 910 may cache the modified A record. With regard to a next incoming DNS query, the fifth local name server 910 may provide the modified A record. Thus, the DNS response speed may be faster and overall load of the internet traffic control system 900 may be reduced.

When the A record is modified with the IP address of the best search guide server, the system construction may be simpler. When the A record is modified with the IP address of the NXDOMAIN controller 970, the centralized non-existing domain traffic control may accomplish more organized and structured control over the non-existing domain traffic control. In addition to processing of the initial internet request as a result of the A record modification, the NXDOMAIN controller 970 may also process incoming DNS queries that result from modification of the NS record described above in connection with FIGS. 2 and 4-6.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. An internet traffic control method for a non-existing domain, comprising:
installing a domain name service (DNS) module;
receiving a DNS query directed to the non-existing domain at the DNS module;
redirecting to a controller the DNS query by the DNS module;
determining at the controller an optimal search guide server operable to provide an alternative response to a non-existing domain request;
sending an IP address of the optimal search guide server to the DNS module; and
forwarding the IP address of the optimal search guide server to a user application which has sent the non-existing domain request, thereby to direct the user application to access the optimal search guide server.

2. The method of claim 1, further comprising:
determining that a first domain name response data packet to the DNS query indicates the non-existing domain; and
upon determination of the first domain name response data packet indicative of the non-existing domain, modifying a name server record of the data packet responsive to the DNS query.

3. The method of claim 1, further comprising:
receiving another DNS query directed to an existing domain;
determining that a second domain name response data packet to another DNS query indicates an existing domain; and
upon determination of the second domain name response data packet indicative of the existing domain, returning existing domain information contained in the second domain name response data packet to the user application which has sent another DNS query without redirection of another DNS query to the controller.

4. The method of claim 1, further comprising:
receiving a domain name of the non-existing domain request, and
evaluating the domain name to determine selected content relevant to the domain name.

5. The method of claim 4, further comprising:
receiving an IP address of the DNS module; and
evaluating the IP address of the DNS module to determine a network location.

6. The method of claim 5, wherein determining the optimal search guide server comprises determining the optimal search guide server operable to store a landing page relevant to the selected content and proximate to the network location wherein the network location indicates a location of the user application.

7. An internet traffic control system for a non-existing domain, comprising:
a DNS module operable to redirect a DNS query for the non-existing domain and comprising a redirector operable to modify a name server record of a domain name response data packet to the DNS query and indicative of the non-existing domain; and
a non-existing domain name controller operable to receive the redirected DNS query and determine an optimal search guide server that provides an alternative response to a non-existing domain response informing a user application of the non-existing domain;
wherein the non-existing domain name controller returns information of the optimal search guide server to the DNS module in response to the redirected DNS query.

8. The system of claim 7, further comprising a plurality of internet service provider systems for providing an internet connection to a user application and in communication with the non-existing domain name controller wherein each internet service provider system comprises the DNS module and directs the user application to obtain a landing page provided by the optimal search guide server.

9. The system of claim 7, further comprising an internet service provider system operable to provide an internet connection to a user application, the internet service provider system comprising the DNS module and the non-existing domain name controller.

10. The system of claim 7, wherein the non-existing domain name controller comprises a first controller and a second controller, the first controller assigned to and in communication with a first internet service provider system and the second controller in communication with the second internet service provider system and located independently of the second internet service provider system, and
wherein the first controller determines the optimal search guide server for the first internet service provider system and the second controller determines the optimal search guide server for the second internet service provider system and a third internet service provider system.

11. The system of claim 7, wherein the non-existing domain name controller comprises:
a database for storing information of the optimal search guide server and criteria that defines the optimal search guide server; and
a logic comprising inputs of a domain name of the non-existing domain and an IP address of the DNS module and an output of an IP address of the optimal search guide server, wherein the logic further operates to refine and update the information of the optimal search guide server and the criteria.

12. The system of claim 8, wherein the DNS module of each internet service provider system comprises a local name server operable to receive the DNS query from the user application and to return a resultant IP address to the user application, and
wherein the redirector intercepts the response data packet indicative of the non-existing domain before the local name server receives the response data packet.

13. The system of claim 8, wherein the DNS module of each internet service provider system comprises a local name server operable to receive the DNS query from the user application and return a resultant IP address to the user application, and
wherein the local name server operates to cache the modified name server record when necessary.

14. An internet traffic control method for a non-existing domain, comprising:
operating a local name server to receive a domain name system (“DNS”) query from a user application comprising a browser wherein the DNS query comprises a first DNS query directed to an existing domain and a second DNS query directed to the non-existing domain;
communicating with an authorized name server to resolve the first and the second DNS queries;
receiving a DNS response from the authorized name server, the DNS response comprising a first DNS response corresponding to the first DNS query and a second DNS response corresponding to the second DNS query;
modifying a record of the second DNS response;
forwarding the first DNS response to the local name server without modification of the record;
receiving the first DNS response and the second DNS response at the local name server;
determining at a non-existing domain controller a search guide server operable to provide an alternative response to the user application which has sent the second DNS query; and
returning a resultant IP address of the search guide server to the user application.

15. The method of claim 14, wherein modifying the record of the domain name resolution response comprises modifying a name server record of a DNS response packet; and further comprising:
redirecting the second DNS query to the non-existing domain name controller based on the modified name server record of the second DNS response wherein the local name server considers the non-existing domain name controller as the authorized name server.

16. The method of claim 14, wherein modifying the record of the domain name resolution response comprises modifying an A record of the DNS response packet to add the resultant IP address of the search guide server.

17. The method of claim 14, wherein modifying the record of the domain name resolution response comprises modifying an A record of the DNS response packet to add the IP address of the non-existing domain controller.

18. The method of claim 14, wherein determining the search guide server comprises:
determining whether the search guide server stores a landing page relevant to a domain name contained in the second DNS query;
determining whether the search guide server is proximate to the user application; and
selecting the search guide server that stores the landing page relevant to the domain name contained in the second DNS query and proximate to the user application.

19. An internet traffic control system for a non-existing domain, comprising:
means for receiving and processing a DNS query from a user application;
means for redirecting the DNS query by modifying a predetermined record of a DNS response data packet to the DNS query, means for redirecting operable to determine that the DNS response data packet indicates the non-existing domain prior to the modification of the predetermined record; and
means for controlling internet traffic directed to the non-existing domain by responding to a redirected DNS query, means for controlling operable to determine an optimal search guide server which provides an alternative response to the user application which has sent the redirected DNS query;
wherein means for controlling further transmits an IP address of the optimal search guide server to the user application.

20. The system of claim 19, wherein the means for controlling further comprises:
means for storing:
content information stored in a group of search guide servers;
a network location of the group of search guide servers; and
predetermined criteria for defining the optimal search guide server at least based on the content information and the network location of the group of search guide servers;
a logic comprising an input of a domain name of the redirected DNS query and network location information of the user application and an output of a resultant search guide server, the logic operable to generate the output based on the predetermined criteria;
wherein the logic is further operable to integrate in real time the content information and the network location of the group of search guide servers and update the predetermined criteria.

21. The system of claim 20, wherein the resultant search guide server is operable to redirect the internet traffic associated with the non-existing domain to another search guide server, another search guide server being more proximate to the user application than the resultant search guide server, storing the content information more enhanced in quality and quantity than the resultant search guide server, or both.
